(19) United States
(12) Patent Application Publication
(10) Pub. No.: US 2006/0220346 A1
(43) Pub. Date: Oct. 5, 2006

(54) CJ insta cart

(76) Inventors: Jimmy DeWayne Fulton, Brookings, OR (US); Carolyn Marie Fulton, Brookings, OR (US)

Correspondence Address: Jimmy DeWayne and Carolyn Marie Fulton, 1331 Heather Lane, P.O. Box 4153, Brookings, OR, 97415, US

(21) Appl. No.: 10/962,807

(22) Filed: Oct. 12, 2004

(51) Int. Cl. B60D 1/155

(52) U.S. Cl. 280/493; 280/491.1; 280/490.1

(57) ABSTRACT

A trailer which can be attached to the rear of a personal mobility vehicle. When not in use, the trailer folds and stores in a carrier attached to the lower framework of the personal mobility vehicle. When needed, the trailer is lifted out of the carrier, the collapsible container is unfolded and the trailer is ready for use. The trailer is attached to the personal mobility vehicle at all times whether in use or not in use by a coupler. The tongue of the trailer is supported by the chassis of the trailer and is adjustable so as to retract or extend as needed. The chassis is attached to the container and also supports the tires and wheels.

### BACKGROUND OF THE INVENTION

The present invention relates, in general, to carriers and trailers which may attach to vehicles such as but not exclusive to personal mobility vehicles, hereafter in this document to be referred to as PMV's, and more particularly to a trailer which is easily attached to a PMV with a specialized hitch or coupler which is part of the trailer. Disabled and handicapped people of all ages have been using personal mobility vehicles for many years but nearly all of these vehicles supply only a small basket on the front or back for carrying just a few items. In certain stores there are PMV's with large baskets on the front for use by the disabled for shopping but these are not available or practical for any person wanting to use it outside of the store. In addition, disabled or handicapped people who own a PMV and are unable to drive a car but live close to their necessary shopping and other conveniences can use their PMV to get to these retail establishments. In many cases these people want to maintain as much independence as possible. The problem then becomes how to get the merchandise back to their home in the small basket furnished on the PMV. Other needs for more storage space with a PMV would be as varied as the people using the trailer attached to their PMV.

In realizing that there is a need for a non-motorized trailer that would travel behind a PMV to haul items, it would be desirable to not only have such a trailer, but to also have such a trailer that would be easy for the disabled or handicapped person to handle and use.

Description of Prior Art

| | | |
|---|---|---|
| 5354090 | Grovom | Collapsible portable trailer for all terrain vehicles |
| 6254117 | Cross | Folding trailer for all-terrain vehicle |
| 6767025 | Hagen | Folding trailer for off-ground storage on a towing |
| | | vehicle |

### SUMMARY OF THE INVENTION

The present invention is a non-motorized trailer to be stored in a carrier made specifically for the trailer and mounted on the rear structure of a vehicle such as but not exclusive to a PMV. The invention is designed for carrying any number of different items including but not limited to groceries or household items as well as a variety of recreational items such as fishing equipment or picnic items. These examples represent only a small variety of the number of items that cannot be carried by the rider of the PMV while operating the PMV.

### BRIEF DESCRIPTION OF THE DRAWINGS

FIG. 1—shows a side view of the trailer (01) folded and stored in the carrier (20) and attached to PMV (02).

FIG. 2—shows the underside of the self-storing, collapsible trailer (01) including the chassis (06) axles (07) and wheels and tires (03). The tongue (09) is mounted onto the chassis (06) with the two holders (30). The tongue (09) is in the retracted position with the tension spring lock with adjusting knob (25) tightened and locked. This is the position that the trailer (01) would be in if it was being placed in the carrier (20) however, it would still be hooked to the coupler (24) on the carrier (20) that is attached to the PMV (02).

FIG. 3—is the same view as FIG. 2 except the tongue (09) is extended and would be hooked up to the coupler (24) on the carrier (20) that is attached to the PMV (02). Neither the PMV (02) or carrier (20) is shown in FIG. 2 and FIG. 3 for obvious size reasons.

<FIG. 4 is canceled>

FIG. 5—shows a somewhat diagonal side and rear view of the trailer (01) unfolded and attached to the PMV (02). Also shown is a partial rear view of the PMV (02) to show a full diagonal side and rear view of the empty carrier (20) including the connection to the PMV (02) as well as the coupler (24) with coupler pin (14) in position with coupler pin locking clip (17) and coupler pin retaining cable (16). This is the position with the trailer ready to tow.

FIG. 6—is a close-up view of the coupler pin receiver (12) on the tongue (09) engaged into the coupler (24) where the coupler pin (14) has been installed and secured with the coupler pin locking clip (17) and the coupler pin retaining cable (16). Also shown is the swivel bolt (19) that allows the coupler (24) to move vertically.

<FIG. 7 is canceled.>

<FIG. 8 is canceled.>

<FIG. 9 is canceled.>

### DETAILED DESCRIPTION OF THE INVENTION

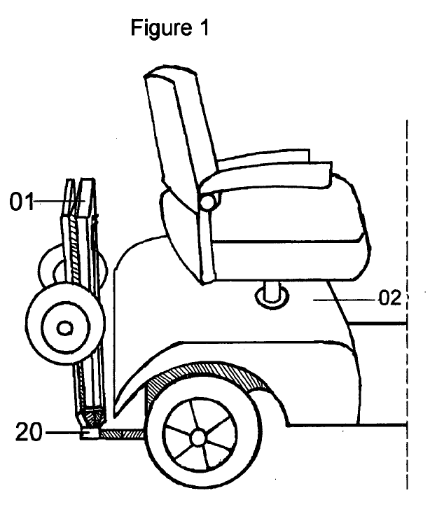

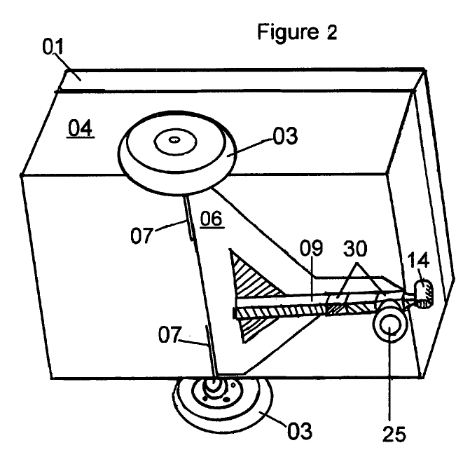

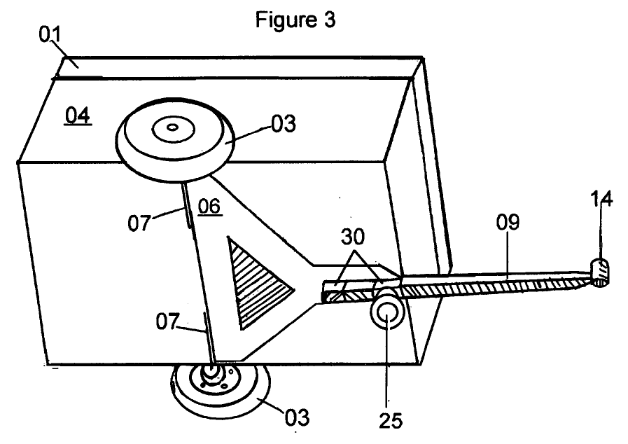

The invention consists of a collapsible, self-storing trailer (01) designed to attach with a coupler (24) to a carrier (20) that is attached to the rear section (26) of a PMV (02). The trailer (01) is made of a rectangular container (04) with four walls which are constructed to fold down in order to make the container flat. FIG. 1 shows a side view of the trailer (01) collapsed and stored in the carrier (20) that is attached to the PMV (2). The chassis (06), axles (07), wheels and tires (03) plus tongue (09) with pin receiver (12) are attached to this container (04) as shown in FIGS. 2 and 3. The chassis (06) is made of one piece of 14 gauge flat metal designed for strength but the lightest weight possible to which the 5/16″ axle (07) is welded and the tires and wheels (03) are installed on these axles (07). The tongue (09) is made of ¾″×¾″ box metal and is mounted inside two separate pieces of 1″×1″ box metal (30) so it will extend and retract. The locking mechanism (25) for the tongue consists of a ¼″ bolt and tension spring with a knurled adjusting knob fitted so it can be tightened down or loosened by finger pressure. The pin receiver (12) welded on the end of the tongue (09) is made of a metal tube approximately ¾″ long and ½″ in diameter.

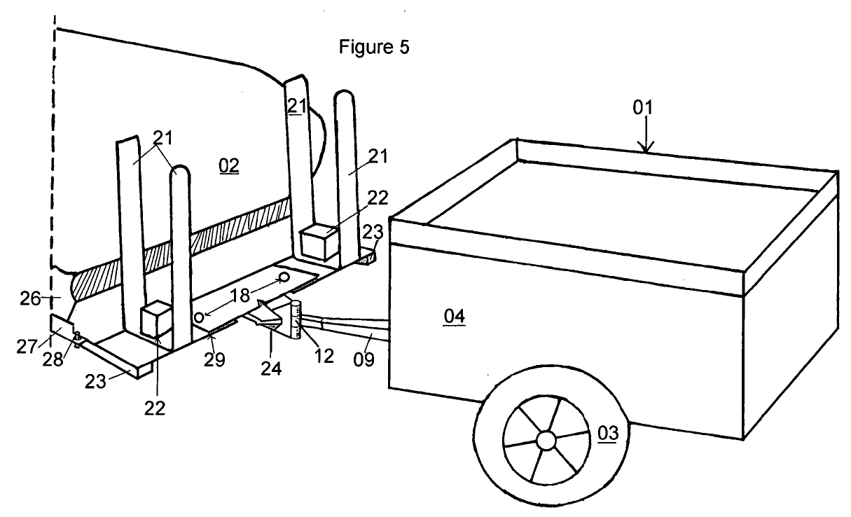

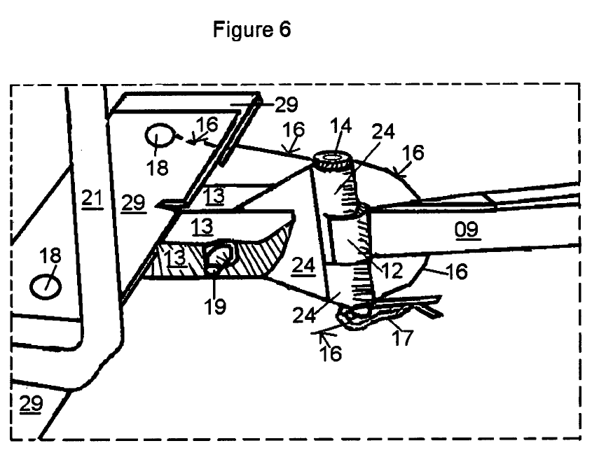

FIG. 5 shows the carrier (20) which consists of a floor (29), vertical support braces (21), container resting posts (22) the coupler (24) and its support structure (13) and the towing vehicle attachment posts (23). The carrier floor (29) consists of three pieces of ⅛″×2″ flat metal attached with bolts (18) for lateral adjustment. Attached to the carrier floor (29) on either side of said floor (29) are two pieces of metal each bent into a “U” shape to form the vertical support braces (21) to accept the trailer (01) in its folded position. FIG. 6 shows a detailed view of the how the coupler (24) is attached to the carrier (20) and how it moves. The coupler support structure (13) is made of two pieces of 1″ angle iron connected to the center section of the carrier floor (29). The coupler (24) is fabricated from two pieces of flat metal configured into two cylindrical shapes and separated by the same size of the pin receiver (12) on the tongue (09). The coupler and the pin receiver are held together by a pin (14) and a coupler pin locking clip (17) with a coupler pin retaining cable (16) attached. The coupler support structure (13) also contains a swivel bolt (19) which will allow the coupler to move in a horizontal direction in order to facilitate the towing of the trailer and 90 degrees in an upward vertical direction to allow the folded trailer (01) to be stored in the carrier (20) without unhooking the connection between the PMV (02) and the trailer (01).

What is claimed is:

1-5. (canceled)

6. A collapsible trailer for towing by a vehicle such as but not exclusive to a personal mobility vehicle, said trailer comprising;
(a) a plastic or metal container substantially rectangular in shape with vertical and parallel side walls, one vertical front wall, one vertical rear wall parallel to said front wall and all the walls attached at the bottom to a flat floor in such a manner as to allow all four vertical walls to fold inward and completely flat to rest on the floor of said container;
(b) a flat metal chassis with a straight rear edge and with one flat edge attached to the bottom of the floor of the container and having the rear edge of the chassis attached laterally at a point midway between and parallel with the points where the front and rear walls attach to the container;
(c) spindles attached on opposite ends of the laterally disposed rear edge of the chassis to form axles on which wheels and tires are mounted so as to rotate on opposite sides of the container;

7. The trailer of claim 6 further comprises;
(a) a tongue made of one piece of square tubular metal that tapers to a point at one end where a coupler pin receiver is attached and a piece of metal slightly larger than the tube on one side attached to the other end to form a stop;
(b) two pieces of box metal attached to the chassis at points to support the tongue and sized in such a manner as to allow the tongue to telescope through these pieces; and
(c) a spring tension lock with a knurled knob attached to one of the pieces of the box metal that are attached to the chassis.

8. The trailer as described in claim 7 when collapsed and not in use is stored in a carrier which is attached to said vehicle, said carrier comprising;
(a) a framework consisting of three substantially rectangular pieces of metal bolted together to form the floor of the carrier, these sections being laterally adjustable and having the ability to be locked in place with two properly spaced adjusting bolts;
(b) two rectangular strips of metal formed into a somewhat “U” shape and attached to the floor of the carrier in a position in which the upright sections will support the trailer when in the collapsed position; and
(c) two supports inside the “U” shaped metal of the carrier to allow the container of the trailer to rest upon when the trailer is in the collapsed position in the carrier;

9. The carrier of claim 8 further comprises;
(a) a metal framework attached to the underside of the floor of the carrier to support a coupler assembly in order to formed to accept the pin receiver attached to the tongue of said trailer;
(b) a coupler pin and pin locking clip sized to fit into coupler assembly when it is fitted with the pin receiver that is on the tongue of the trailer; and
(c) the coupler assembly having pivot ability to horizontally pivot for ease of towing the trailer and pivot ability of 90 degrees vertically upward in order to allow movement for storage of said collapsed trailer.

10. The carrier of claim 9 further comprises two square metal sections attached on both ends of the underside of the floor of the carrier to use for attachment to the towing vehicle.
